(19) United States
(12) Patent Application Publication
(10) Pub. No.: US 2015/0036042 A1
(43) Pub. Date: Feb. 5, 2015

(54) METHOD FOR ADJUSTING ILLUMINATION DIRECTION ANGLE OF STROBE DEVICE, STROBE DEVICE, AND IMAGING DEVICE EQUIPPED WITH STROBE DEVICE

(71) Applicant: Panasonic Intellectual Property Management Co., Ltd., Osaka (JP)

(72) Inventors: Takashi Umehara, Osaka (JP); Kazuhiko Ooyama, Hyogo (JP); Katsunori Kawabata, Kyoto (JP)

(21) Appl. No.: 14/394,520

(22) PCT Filed: Apr. 10, 2013
(86) PCT No.: PCT/JP2013/002428

§ 371 Date: Oct. 15, 2014

(30) Foreign Application Priority Data
Apr. 17, 2012 (JP) 2012-093627

(51) Int. Cl. H04N 5/225; H04N 5/235

(52) U.S. Cl. CPC H04N 5/2256; H04N 5/2354
USPC 348/371

(57) ABSTRACT

A method for adjusting the illumination direction angle of a strobe device includes the steps of: transmitting to a specific strobe device, a first signal related to the present illumination direction angle of the strobe device being adjusted; based on the first signal, causing the illumination direction angle of the specific strobe device to correspond to the illumination direction angle of the strobe device being adjusted; changing the illumination direction angle of the specific strobe device to a state desirable for the strobe device being adjusted; transmitting, to the strobe device being adjusted, the amount of further change in the illumination direction angle of the specific strobe device, as a second signal; and changing the illumination direction angle of the strobe device being adjusted, based on the second signal. With this method, the illumination direction angle of the strobe device can be remotely adjusted.

This application is a U.S. National Phase Application of PCT International Application PCT/JP2013/002428.

### TECHNICAL FIELD

The present invention relates to a method for adjusting the illumination direction angle of a strobe device, the strobe device, and an imaging device equipped with the strobe device in stroboscopic photography using a plurality of strobe devices.

### BACKGROUND ART

Conventionally, stroboscopic photography in which an object is photographed using a plurality of strobe devices has been performed (see Patent Literature 1, for example). At this time, each of the strobe devices is disposed in the position suitable for the object, e.g. on the front side, rear side, vertical side, and horizontal side of the object.

However, in stroboscopic photography using a plurality of strobe devices, the photographer needs to adjust the illumination direction angle of each strobe device. Thus, the photographer needs to move to the proximity of the strobe device to be adjusted and change the illumination direction angle of the corresponding strobe device. As a result, the operability or workability is reduced and the photographer cannot take a photograph with good timing.

### CITATION LIST

### Patent Literature

PTL1 Japanese Patent Unexamined Publication No. 2011-095473

### SUMMARY OF THE INVENTION

In order to address the above problems, a method for adjusting the illumination direction angle of a strobe device of the present invention includes the following steps of:

transmitting to a specific strobe device, a first signal related to a present illumination direction angle of the strobe device being adjusted;

based on the first signal, causing an illumination direction angle of the specific strobe device to correspond to the illumination direction angle of the strobe device being adjusted;

changing the illumination direction angle of the specific strobe device to a state desirable for the strobe device being adjusted;

transmitting to the strobe device being adjusted, a second signal representing an amount of further change in the illumination direction angle of the specific strobe device, as a second signal; and

based on the second signal, changing the illumination direction angle of the strobe device being adjusted.

With this method, the second signal is transmitted from the specific strobe device to the strobe device being adjusted, and thereby the illumination direction angle of the strobe device being adjusted is changed to the desired illumination direction angle. As a result, operating the specific, self strobe device can adjust the illumination direction angle of the other strobe device being remotely adjusted.

Each of strobe devices of the present invention includes a strobe body, a light-emitting part, a signal transmitter-receiver, and a controller. The controller of a self strobe device changes an illumination direction angle of the self strobe device, based on a first signal related to the present illumination direction angle of another strobe. Further, the controller of the self strobe device controls such that the amount of change from the changed illumination direction angle to the further changed illumination direction angle is transmitted, as a second signal, from the signal transmitter-receiver to the other strobe device. The controller of the other strobe device controls such that the illumination direction angle of the other strobe device is changed based on the second signal.

With this configuration, the second signal is transmitted to the other strobe device, and thereby the illumination direction angle of the other strobe device is changed to the desired illumination direction angle. As a result, the illumination direction angle of the other strobe device can be remotely adjusted in the position of the self strobe device.

Each of strobe devices of the present invention includes a strobe body, a light-emitting part capable of changing an illumination direction angle thereof, a signal transmitter-receiver, and a controller. The controller of a self strobe device controls such that a first signal related to a present illumination direction angle of the self strobe device is transmitted to another strobe device. When an illumination direction angle of the other strobe device changed based on the first signal is further changed, the controller of the other strobe device controls such that the amount of change from the changed illumination direction angle to the further changed illumination direction angle is transmitted as a second signal. Further, the controller of the self strobe device controls such that the illumination direction angle of the self strobe device is changed based on the second signal.

With this configuration, the second signal is transmitted from the other strobe device, and thereby the illumination direction angle of the self strobe device is changed to the desired illumination direction angle. As a result, the illumination direction angle of the self strobe device can be remotely adjusted in the position of the other strobe device.

Each of strobe devices of the present invention includes a strobe body, a light-emitting part capable of changing an illumination direction angle thereof, a signal transmitter-receiver, a controller, and a selector. The selector has a first mode for changing the illumination direction angle of another strobe device, and a second mode for changing the illumination direction angle of a self strobe device. When the selector of the self strobe device is in the first mode, the following control is performed. The controller of the self strobe device changes the illumination direction angle of the self strobe device, based on a received first signal related to the present illumination direction angle of the other strobe device. Further, the controller of the self strobe device controls such that the amount of change from the illumination direction angle changed based on the first signal to the further changed illumination direction angle is transmitted, as a second signal, to the other strobe device. The controller of the other strobe device controls such that the illumination direction angle of the other strobe device is changed based on the second signal. When the selector of the self strobe device is in the second mode, the following control is performed. The controller of the self strobe device controls such that the present illumination direction angle of the self strobe device is transmitted to the other strobe device. When the changed illumination direction angle of the other strobe device is further changed, the controller of the other strobe device controls such that the amount of change from the changed illumination direction angle to the further changed illumination direction angle is transmitted as a second signal. The controller of the self strobe device controls such that the illumination direction angle of the self strobe device is changed based on the second signal.

With this configuration, the second signal is transmitted to the other strobe device, and thereby the illumination direction angle of the other strobe device is changed to the desired illumination direction angle. As a result, the illumination direction angle of the other strobe device can be remotely adjusted in the position of the self strobe device. Alternatively, the second signal is transmitted from the other strobe device, and thereby the illumination direction angle of the self strobe device is changed to the desired illumination direction angle. As a result, the illumination direction angle of the self strobe device can be remotely adjusted in the position of the other strobe device.

An imaging device of the present invention includes the above strobe device. This configuration provides an imaging device that has excellent operability and workability and can take a photograph with good timing.

### BRIEF DESCRIPTION OF DRAWINGS

FIG. 1 is a block diagram showing a configuration of an imaging device in accordance with an exemplary embodiment of the present invention.

FIG. 2 is a side view of a strobe device in accordance with the exemplary embodiment.

FIG. 3 is a top view of the strobe device in accordance with the exemplary embodiment.

FIG. 4A is a diagram for explaining a vertical illumination range settable for the strobe device in accordance with the exemplary embodiment.

FIG. 4B is a diagram for explaining a horizontal illumination range settable for the strobe device in accordance with the exemplary embodiment.

FIG. 5 is a block diagram of the strobe device in accordance with the exemplary embodiment.

FIG. 6 is a diagram showing a photographing state in multi-light stroboscopic photography using the strobe devices in accordance with the exemplary embodiment.

FIG. 7 is a control flowchart of a controller of the strobe device in accordance with the exemplary embodiment.

FIG. 8 is a control flowchart of the controller of the strobe device in accordance with the exemplary embodiment.

FIG. 9 is a control flowchart of the controller of the strobe device in accordance with the exemplary embodiment.

### DESCRIPTION OF EMBODIMENT

Hereinafter, a description is provided for a method for adjusting the illumination direction angle of a strobe device, the strobe device, and an imaging device equipped with the strobe device in accordance with an exemplary embodiment of the present invention, with reference to the accompanying drawings. The exemplary embodiment to be described below is an example where the present invention is embodied, and does not limit the technical scope of the present invention.

### Exemplary Embodiment

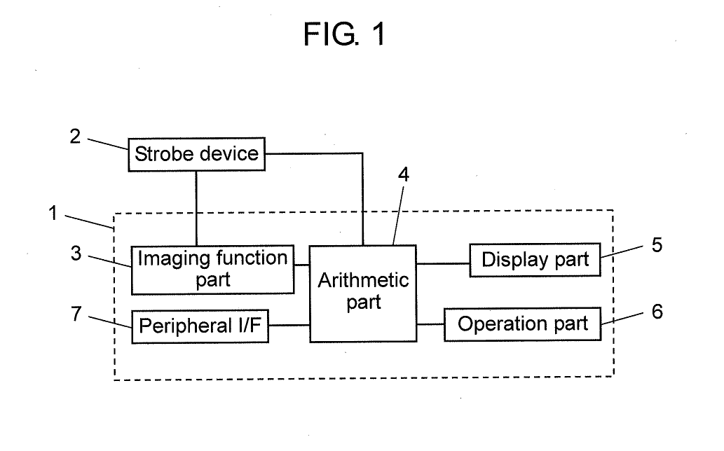

Hereinafter, a description is provided for a strobe device and an imaging device equipped with the strobe device in accordance with the exemplary embodiment of the present invention, with reference to FIG. 1 through FIG. 5.

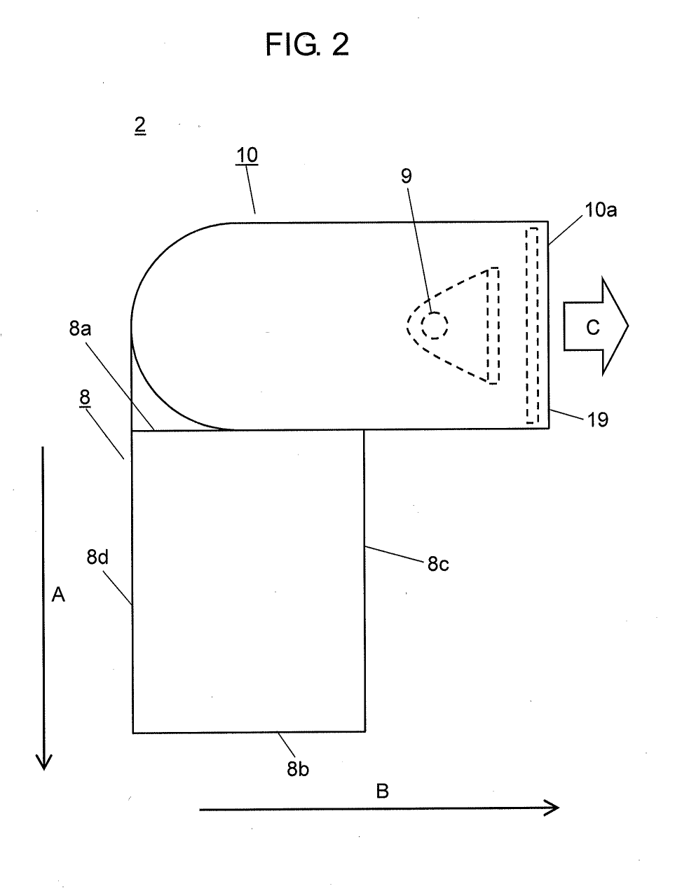

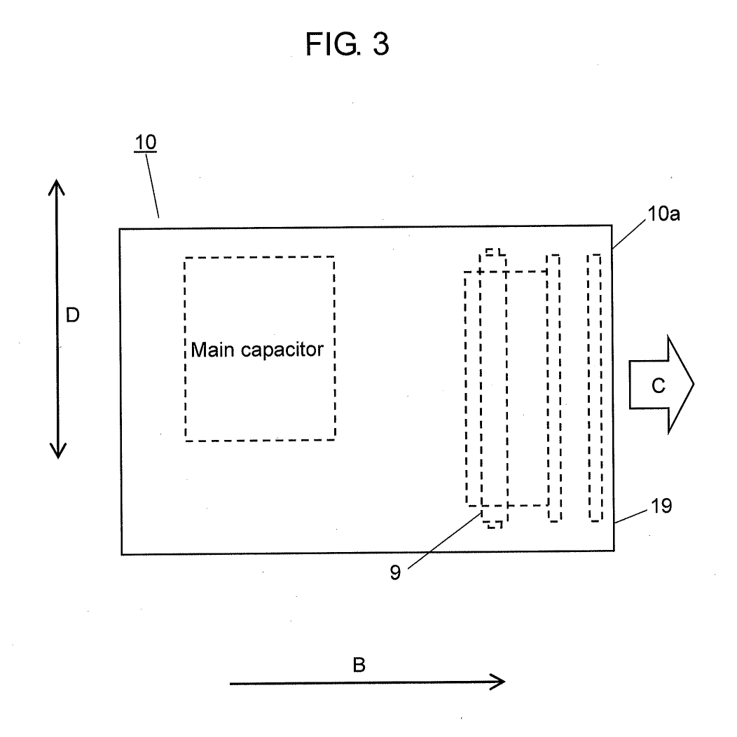

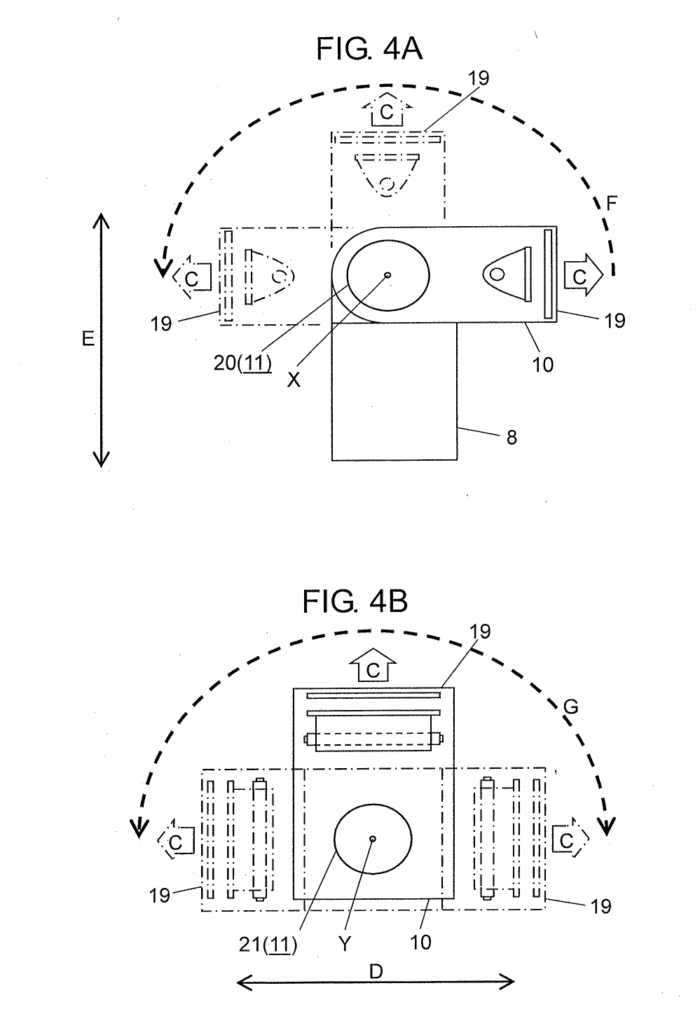

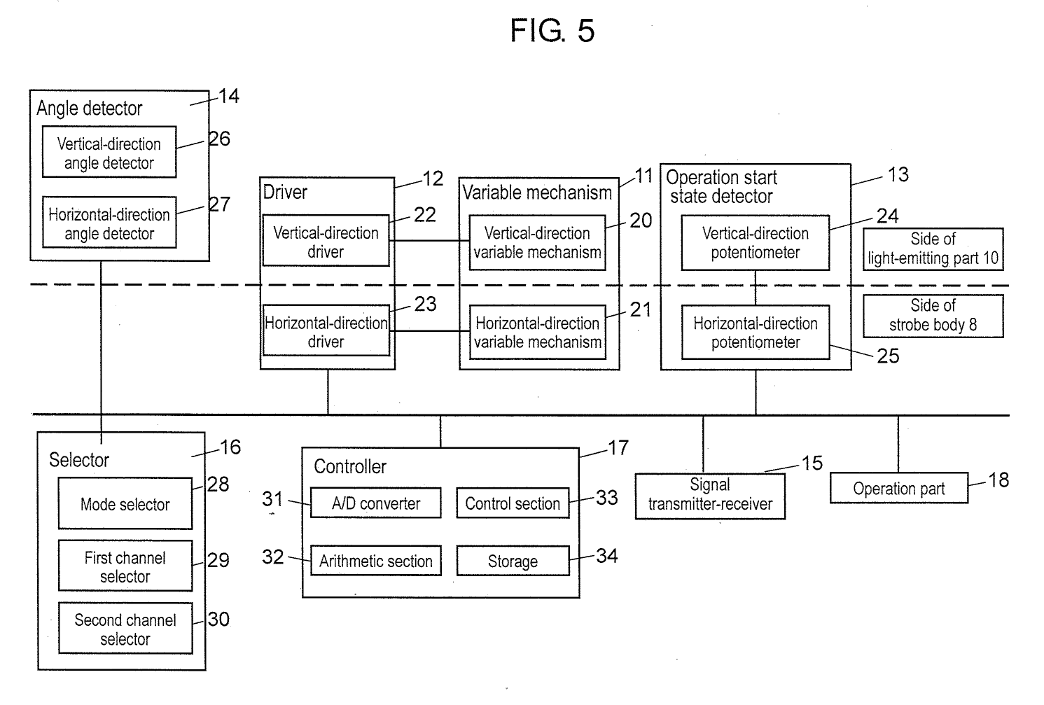

FIG. 1 is a block diagram showing a configuration of an imaging device in accordance with the exemplary embodiment of the present invention. FIG. 2 is a side view of a strobe device in accordance with the exemplary embodiment. FIG. 3 is a top view of the strobe device in accordance with the exemplary embodiment. FIG. 4A is a diagram for explaining a vertical illumination range settable for the strobe device in accordance with the exemplary embodiment. FIG. 4B is a diagram for explaining a horizontal illumination range settable for the strobe device in accordance with the exemplary embodiment. FIG. 5 is a block diagram of the strobe device in accordance with the exemplary embodiment.

As shown in FIG. 1, imaging device 1 of the exemplary embodiment includes the following elements: imaging function part 3 for imaging an object; arithmetic part 4; display part 5; operation part 6; and peripheral interface (I/F) 7. Strobe device 2 for radiating strobe light to the object is attachably (detachably) mounted to imaging device 1.

Arithmetic part 4 controls strobe device 2 and imaging function part 3. Display part 5 displays an image of a photographed object, for example. Operation part 6 is used to set photographing conditions and switch power on and off. Peripheral I/F 7 allows input and output of image data, for example, between imaging device 1 and peripheral devices.

Strobe device 2 of the exemplary embodiment has a configuration suitable for multi-light stroboscopic photography, for example, in which an object is photographed, using plurality of strobe devices 2 including a specific strobe device and a strobe device being adjusted. In some cases in the following description, the specific strobe device may be referred to as a “self strobe device”, and the strobe device being adjusted as “other strobe device”.

That is, as shown in FIG. 2 through FIG. 5, each of plurality of strobe devices 2 in the exemplary embodiment includes the following elements: strobe body 8 made of a casing in a rectangular shape, for example; light-emitting part 10 for housing flash discharge tube 9; variable mechanism 11; driver 12; operation start state detector 13; angle detector 14; signal transmitter-receiver 15; selector 16; controller 17; and operation part 18. Light-emitting part 10 houses flash discharge tube 9 therein, and emits light radiated from flash discharge tube 9 toward the outside. Variable mechanism 11 changes the angle of light-emitting part 10 with respect to strobe body 8 such that the illumination direction angle is changed. Driver 12 drives variable mechanism 11. Operation start state detector 13 detects the operation start state when the angle of light-emitting part 10 with respect to strobe body 8 is changed by the photographer, for example, from the outside. Angle detector 14 detects the angle of light-emitting part 10 with respect to strobe body 8. Signal transmitter-receiver 15 transmits signals to and receives signals from other strobe device 2. For instance, selector 16 is used to select the illumination direction angle adjusting mode for adjusting the illumination direction angle of strobe device 2. Controller 17 controls the angle (position) of light-emitting part 10 with respect to strobe body 8. Operation part 18 is disposed on strobe body 8 and allows the photographer to set a desired illumination direction angle.

As shown in FIG. 2, light-emitting part 10 is rotatably connected to the side of top face 8a of strobe body 8. Further, imaging device 1 shown in FIG. 1 is connectably disposed on the side of bottom face 8b of strobe body 8. Strobe body 8 is connected to imaging device 1 such that the front face of the strobe body is directed along imaging direction B (i.e. the direction of the optical axis of the imaging lens, see FIG. 1 and FIG. 2) of imaging device 1. At this time, the strobe body is connected to imaging device 1 such that front face 8c of strobe body 8 is directed along imaging direction B of imaging device 1.

Light-emitting part 10 is formed of a casing in a substantially rectangular (including rectangular) shape, for example, and has opening 19 for radiating light emitted from flash discharge tube 9, on the side of one face 10a of the casing. Light-emitting part 10 is configured such that changing the tilt angle of opening 19 with respect to vertical direction A (see FIG. 2) via variable mechanism 11 can change illumination direction C (see FIG. 2) in which strobe light is radiated.

As shown in FIG. 4A and FIG. 4B, variable mechanism 11, which is formed of vertical-direction variable mechanism 20 and horizontal-direction variable mechanism 21, rotatably connects strobe body 8 and light-emitting part 10. Specifically, vertical-direction variable mechanism 20 of variable mechanism 11 is connected rotatably in vertical direction F around rotary shaft X (see FIG. 4A), which is disposed along width direction D (see FIG. 3) of strobe body 8. Horizontal-direction variable mechanism 21 of variable mechanism 11 is connected rotatably in horizontal direction G around rotary shaft Y (see FIG. 4B), which is disposed along vertical direction E (i.e. the height direction, see FIG. 4A) of strobe body 8.

As shown in FIG. 5, driver 12 has vertical-direction driver 22 including a vertical-direction driving motor for rotatably driving vertical-direction variable mechanism 20, and horizontal-direction driver 23 including a horizontal-direction driving motor for rotatably driving horizontal-direction variable mechanism 21.

As shown in FIG. 5, operation start state detector 13 detects that variable mechanism 11 starts to move when the angle of light-emitting part 10 with respect to strobe device 8 is rotated by the photographer, for example, from the outside. Hereinafter, the state where variable mechanism 11 starts to move is referred to as an “operation start state”. Operation start state detector 13 detects rotation of vertical-direction variable mechanism 20. For instance, operation start state detector 13 has rotary vertical-direction potentiometer 24 for detecting rotation of vertical-direction variable mechanism 20, and rotary horizontal-direction potentiometer 25 for detecting rotation of horizontal-direction variable mechanism 21.

As shown in FIG. 5, angle detector 14 has vertical-direction angle detector 26 and horizontal-direction angle detector 27, and is disposed in strobe body 8. Vertical-direction angle detector 26 detects the tilt angle of light-emitting part 10 in vertical direction A. Horizontal-direction angle detector 27 detects the rotation angle of light-emitting part 10 with respect to horizontal direction G.

In the exemplary embodiment, vertical-direction angle detector 26 is formed of a triaxial acceleration sensor for detecting acceleration in three directions, i.e. those along X, Y, and X axes, for example. By detecting gravitational acceleration in the static state with the triaxial acceleration sensor, the tilt angle of light-emitting part 10 (the position of light-emitting part 10) in the vertical direction is detected. In the exemplary embodiment, horizontal-direction angle detector 27 is formed of a geomagnetism sensor for detecting the magnitude and direction of the magnetic field. By detecting, with the geomagnetism sensor, an azimuth to which light-emitting part 10 is directed, the tilt angle of light-emitting part 10 (the position of light-emitting part 10) in the horizontal direction is detected.

As shown in FIG. 5, signal transmitter-receiver 15 is an input/output interface, and allows remote communication between self strobe device 2 and one of or one group of other strobe devices 2, for example, using a communication system, such as wireless communication. Specifically, signal transmitter-receiver 15 of self strobe device 2 transmits signals including the following information: information to be transmitted to destinations, i.e. the signal transmitters-receivers of one of or one group of other strobe devices 2; and identification information, e.g. channels, to be used to identify one of or one group of other strobe devices 2. This allows communication between self strobe device 2 and other strobe devices 2. The identification information means a characteristic value given in advance or a set value set as needed to each strobe device 2 to allow one of or one group of other strobe devices 2 to be identified.

The identification information of the exemplary embodiment is a set value set to each strobe device 2 as needed, and will be described as a “channel” hereinafter. The channel may be individually set to each of other strobe devices 2, or collectively set to one group of other strobe devices 2.

As shown in FIG. 5, selector 16 includes mode selector 28, first channel selector 29, and second channel selector 30. Mode selector 28 is used to select a master mode and a remote mode, which correspond to a “first mode” and a “second mode”, respectively, in the exemplary embodiment. In the master mode, the illumination direction angle of light-emitting part 10 with respect to strobe body 8 in other strobe device 2 is changed. In the remote mode, other strobe device 2 in the master mode changes the illumination direction angle of light-emitting part 10 of self strobe device 2. When the master mode is selected using mode selector 28, the channel of strobe device 2 in the remote mode is selected using first channel selector 29 and the channel of self strobe device 2 is selected using second channel selector 30.

As shown in FIG. 5, controller 17 includes A/D converter 31, arithmetic section 32, control section 33, and storage 34. A/D converter 31 performs A/D conversion on a detection signal detected by angle detector 14 and a signal received by signal transmitter-receiver 15. Based on a value converted by A/D converter 31, arithmetic section 32 calculates the rotation angle at which light-emitting part 10 is to be operated. Based on the rotation angle calculated by arithmetic section 32, control section 33 drives driver 12 and controls the position of light-emitting part 10. Storage 34 is used to store identification information, for example, given to one of or one group of strobe devices 2, including self strobe device 2 and other strobe devices 2.

Hereinafter, a specific description is provided for the operation of controller 17 in the exemplary embodiment.

First, a description is provided for an example where self strobe device 2 is selected as the master mode, via controller 17, using mode selector 28 of selector 16.

At this time, suppose signal transmitter-receiver 15 of self strobe device 2 receives a first signal related to a present illumination direction angle of other strobe device 2 in the remote mode (hereinafter, being referred to as a “remote strobe device”), from the remote strobe device. Then, the illumination direction angle of self strobe device 2 is changed based on the first signal.

That is, controller 17 causes driver 12 to move variable mechanism 11 and rotate light-emitting part 10, and thereby changes the illumination direction angle of self strobe device 2 set to the master mode such that the illumination direction angle thereof corresponds to the illumination direction angle of the remote strobe device, which is specified based on the first signal. Thus, the illumination direction angle of self strobe device 2 is changed to a state desirable for the remote strobe device (the illumination direction angle most suitable for photography).

When the illumination direction angle changed based on the first signal is further rotated in self strobe device 2, controller 17 thereof transmits the amount of rotation (corresponding to the “amount of change” in the exemplary embodiment), as a second signal, from signal transmitter-receiver 15 to the remote strobe device. At this time, the illumination direction angle of the remote strobe device that has received the second signal is changed based on the second signal related to the illumination direction angle of self strobe device 2. Thus, the illumination direction angles of self strobe device 2 and other strobe device 2 are set to an illumination direction angle desirable for the photographer.

Next, a description is provided for an example where self strobe device 2 is selected as the remote mode, via controller 17, using mode selector 28 of selector 16.

At this time, controller 17 transmits a first signal related to a present illumination direction angle of self strobe device 2 from signal transmitter-receiver 15 to other strobe device 2 in the master mode (hereinafter, being referred to as a “master strobe device”).

Suppose, in the master strobe device, the illumination direction angle changed based on the first signal is further changed by the photographer, for example, who rotates the angle of light-emitting part 10 with respect to strobe body 8. In this case, controller 17 of the master strobe device transmits, as a second signal, the amount of rotation (change) of the illumination direction angle of the master strobe device from the illumination direction angle caused by rotation of variable mechanism 11 based on the first signal to the further changed illumination direction angle. At this time, in self (remote) strobe device 2, based on the second signal received by signal transmitter-receiver 15 thereof, controller 17 causes driver 12 to move variable mechanism 11 and rotate light-emitting part 10, and thereby changes the illumination direction angle. Thus, the illumination direction angles of self strobe device 2 and other strobe device 2 are set to an illumination direction angle desirable for the photographer. At this time, when operation start state detector 13 detects an operation start state, controller 17 causes driver 12 to move variable mechanism 11 in response to the change, and thereby changes the angle of light-emitting part 10.

Operation part 18 shown in FIG. 5 is disposed on rear face 8d of strobe body 8, and forms part of the input/output interface to be used to set or change the photographing conditions, for example, of strobe device 2. The information that has been directly or indirectly set or changed by the operation of operation part 18 is stored in storage 34 of controller 17, and is given to control section 33 as a direct or indirect command. When strobe device 2 (or only light-emitting part 10) is tilted at a desired illumination direction angle, operation part 18 allows angle detector 14 to detect the tilt angle and allows arithmetic section 32 to set the desired illumination direction angle.

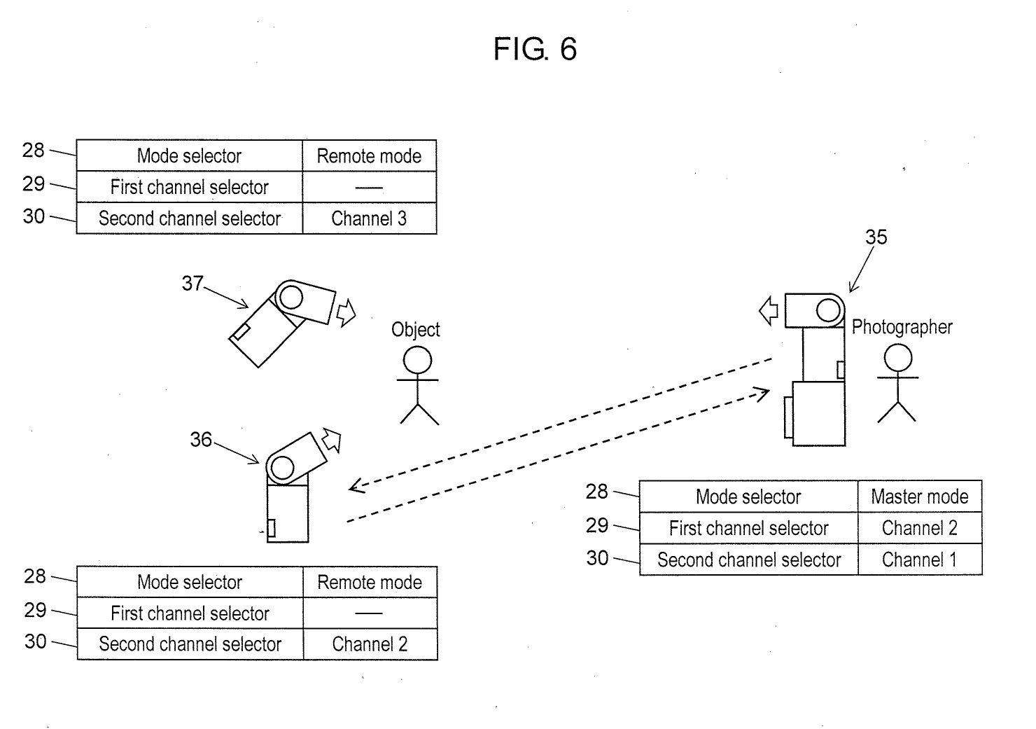

Next, a description is provided for a method for adjusting the illumination direction angles of a plurality of strobe devices when an object is photographed using the plurality of strobe devices in the exemplary embodiment, with reference to FIG. 6 through FIG. 9. In the example in the following description, multi-light stroboscopic photography is performed using three strobe devices, i.e. first strobe device 35, second strobe device 36, and third strobe device 37. However, the present invention is not limited to this example.

FIG. 6 is a diagram showing a photographing state in multi-light stroboscopic photography using the strobe devices in accordance with the exemplary embodiment.

As shown in FIG. 6, a channel for discriminating a self strobe device from the other strobe devices is allocated to each of first strobe device 35, second strobe device 36, and third strobe device 37. Specifically, the photographer selects a channel with second channel selector 30 in selector 16 of each of first strobe device 35, second strobe device 36, and third strobe device 37. Thereby, a channel is allocated to each strobe device. For instance, “channel 1” is selected in first strobe device 35, “channel 2” is selected in second strobe device 36, and “channel 3” is selected in third strobe device 37. The channel selected using second channel selector 30 in selector 16 of each of first strobe device 35, second strobe device 36, and third strobe device 37 is stored correspondingly in storage 34 of controller 17 of each of first strobe device 35, second strobe device 36, and third strobe device 37.

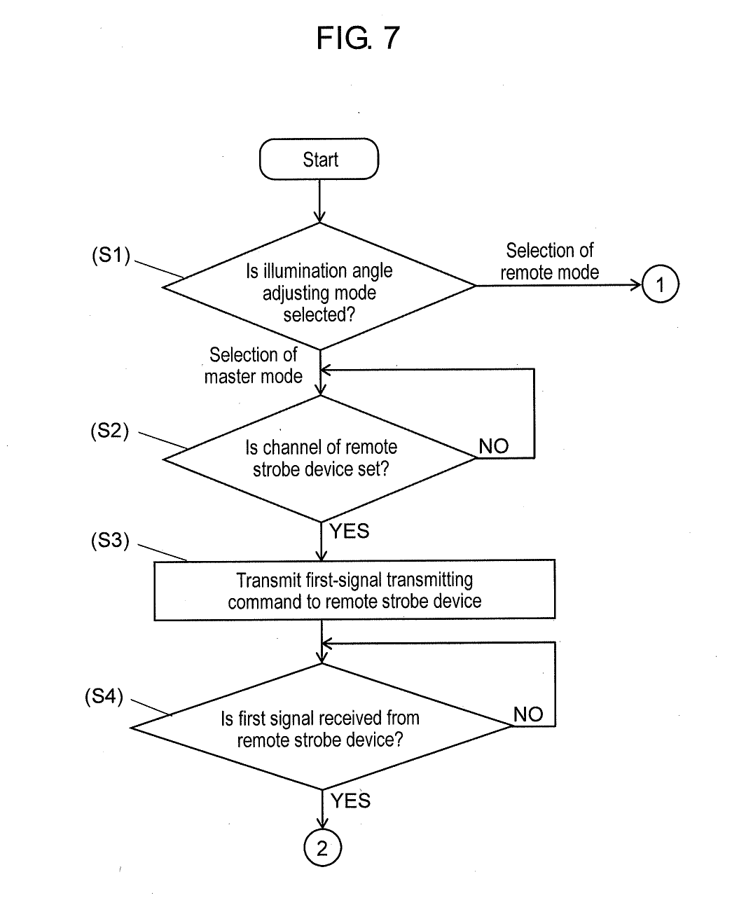

Next, a description is provided for a method for adjusting the illumination direction angles of the plurality of strobe devices of the exemplary embodiment, with reference to FIG. 6, using FIG. 7 through FIG. 9. Hereinafter, a description is provided for a method for adjusting the illumination direction angles of strobe devices in the example of first strobe device 35 and second strobe device 36. Third strobe device 37 also operates in a manner similar to the following description in each of the master mode and the remote mode selected, and the description thereof is omitted.

Each of FIG. 7 through FIG. 9 is a control flowchart of a controller of the strobe device in accordance with the exemplary embodiment.

As shown in FIG. 6, first, the photographer selects the illumination direction angle adjusting mode (master mode/remote mode) of each of first strobe device 35, second strobe device 36, and the third strobe device. In the exemplary embodiment, first strobe device 35, for example, in the proximity of the photographer, is set to the master mode using mode selector 28. Second strobe device 36 and third strobe device 37 are set to the remote mode using respective mode selectors 28.

In the above state, as shown in FIG. 7, it is determined whether the illumination direction angle adjusting mode of each of first strobe device 35, second strobe device 36, and the third strobe device is selected as the master mode or the remote mode (Step S1).

Next, when first strobe device 35 is selected as the master mode and set to a master strobe device (selection of master mode in Step S1) as described above, the following operation is performed. In order to adjust, in the position of first strobe device 35, the angle of light-emitting part 10 of second strobe device 36 set to a remote strobe device by selection of the remote mode, it is determined whether the channel of second strobe device 36 is set or not (Step S2). At this time, channel 2 is selected using first channel selector 29 of first strobe device 35 in the master mode. Channel 2 selected using first channel selector 29 is stored in storage 34 of controller 17.

Next, when the channel of second strobe device 36 as a remote strobe device is set (YES in Step 2), controller 17 of first strobe device 35 transmits, to second strobe device 36, a command of transmitting a first signal related to the present illumination direction angle of second strobe device 36 (Step S3). Thus, the first signal related to the present illumination direction angle of second strobe device 36 is transmitted to first strobe device 35. When the channel of second strobe device 36 as a remote strobe device is not set (No in Step S2), control waits until the channel is set.

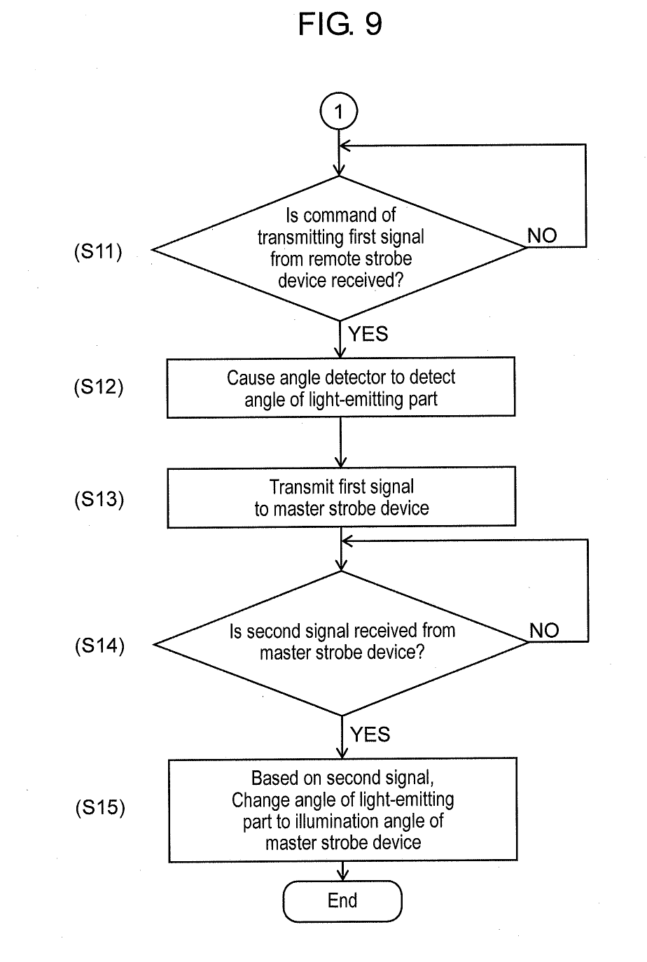

A description is provided for the operation of second strobe device 36 when second strobe device 36 is selected as the remote mode as shown in FIG. 7 (selection of remote mode in Step S1), with reference to FIG. 9.

First, in Step S3, it is determined whether or not the first-signal-transmitting command transmitted from signal transmitter-receiver 15 of first strobe device 35 has been received by second strobe device 36 as a remote strobe device (Step S11). At this time, when signal transmitter-receiver 15 of second strobe device 36 has received the first-signal-transmitting command from first strobe device 35 (YES in Step S11), controller 17 of second strobe device 36 causes angle detector 14 to detect a present angle of light-emitting part 10 before adjustment (Step S12). When signal transmitter-receiver 15 of second strobe device 36 has not received the first-signal-transmitting command from first strobe device 35 (No in Step S11), control waits until the command is received.

Next, in second strobe device 36, A/D converter 31 performs A/D conversion on the detection signal detected by angle detector 14 and the converted value is input to arithmetic section 32. Storage 34 stores the converted value in arithmetic section 32, as the present angle of light-emitting part 10 before adjustment (initial value).

Next, controller 17 of second strobe device 36 transmits, to first strobe device 35, the first signal that corresponds to the illumination direction angle of the self (second) strobe device detected by angle detector 14 (Step S13).

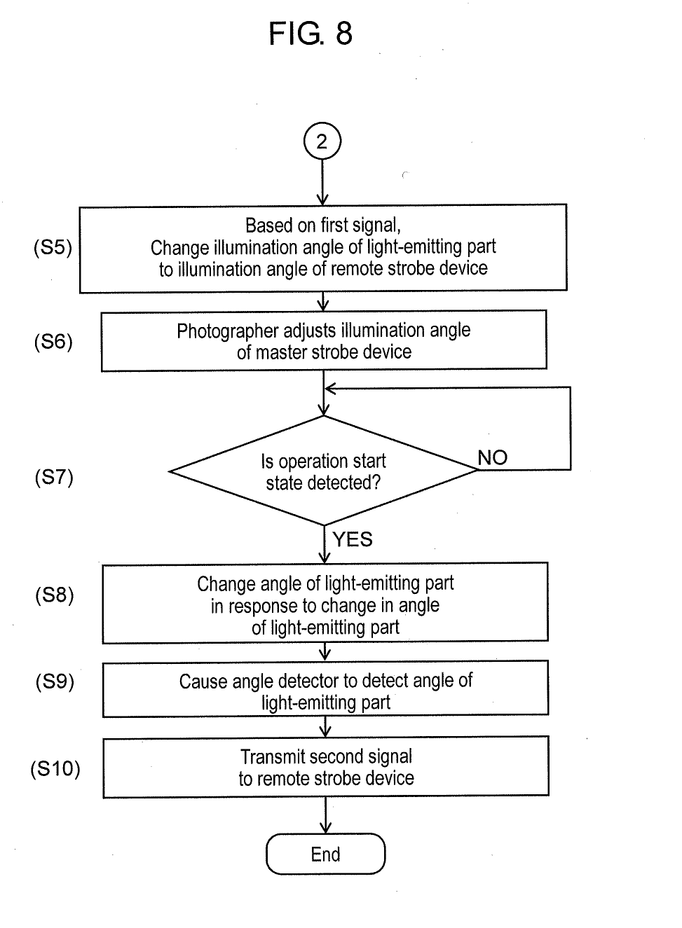

Next, as shown in FIG. 7, it is determined whether or not signal transmitter-receiver 15 of first strobe device 35 has received the first signal transmitted from second strobe device 36 as a remote strobe device (Step S4). At this time, when the first signal is received (YES in Step S4), based on the first signal, controller 17 of first strobe device 35 changes the illumination direction angle thereof such that the illumination direction angle becomes equal to that of second strobe device 36, as shown in FIG. 8 (Step S5). When the first signal is not received (No in Step S4), control waits for a predetermined time until the signal is received.

Next, the photographer confirms that the angle of light-emitting part 10 of first strobe device 35 is changed to the present angle of light-emitting part 10 of second strobe device 36. Then, by rotating light-emitting part 10 of first strobe device 35, the photographer adjusts the illumination direction angle of first strobe device 35 (Step S6). That is, the photographer adjusts the angle of light-emitting part 10 of first strobe device 35 by rotating the angle of light-emitting part 10 of first strobe device 35 in the proximity of the photographer such that the angle thereof corresponds to the angle of light-emitting part 10 of second strobe device 36 in a remote position.

Next, it is determined whether or not operation start state detector 13 of first strobe device 35 has detected an operation start state where the angle of light-emitting part 10 with respect to strobe body 8 is changed (Step S7). At this time, when operation start state detector 13 has detected the operation start state (YES in Step S7), the angle of light-emitting part 10 is changed in response to the change in the angle of light-emitting part 10 of first strobe device 35 (Step S8). When operation start state detector 13 of first strobe device 35 does not detect the operation start state (No in Step S7), control waits until the detection, and is completed after a lapse of predetermined time.

At the same time, angle detector 14 of first strobe device 35 detects the amount of rotation (change) of the illumination direction angle of strobe body 8 of the self (first) strobe device beginning from the present illumination direction angle (Step S9).

Next, controller 17 of first strobe device 35 causes signal transmitter-receiver 15 to transmit the amount of rotation of light-emitting part 10 of the self (first) strobe device detected by angle detector 14, as a second signal, to signal transmitter-receiver 15 of second strobe device 36 (Step S10).

As shown in FIG. 9, it is determined whether or not the second signal transmitted from signal transmitter-receiver 15 of first strobe device 35 has been received by second strobe device 36 (Step S14). At this time, when signal transmitter-receiver 15 of second strobe device 36 has received the second signal from first strobe device 35 (YES in Step S14), controller 17 of second strobe device 36 performs the following control in order to set the illumination direction angle thereof to the illumination direction angle of first strobe device 35 after rotation. Based on the second signal, the controller of the second strobe device causes driver 12 to move variable mechanism 11 and rotate light-emitting part 10 by the amount of rotation (Step S15). Thus, the illumination direction angle of second strobe device 36 is set to the illumination direction angle of first strobe device 35 after rotation.

The above operation is summarized. First, first strobe device 35 in the master mode changes the illumination direction angle of first strobe device 35 such that the illumination direction angle thereof corresponds to the present illumination direction angle of second strobe device 36 in the remote mode, based on a first signal transmitted from second strobe device 36. When the photographer changes the illumination direction angle of first strobe device 35 to the illumination direction angle desirable for second strobe device 36, a second signal is transmitted from first strobe device 35 to second strobe device 36 and thereby the illumination direction angle of second strobe device 36 is changed to the desired illumination direction angle. Thus, in multi-light stroboscopic photography using a plurality of strobe devices, the illumination direction angle of second strobe device 36 can be remotely adjusted in the position of first strobe device 35.

Alternatively, second strobe device 36 in the remote mode transmits the first signal to first strobe device 35 and thereby the illumination direction angle of first strobe device 35 is changed so as to correspond to the illumination direction angle of second strobe device 36. When the photographer changes the illumination direction angle of first strobe device 35 to the illumination direction angle desirable for second strobe device 36, the second strobe device receives the illumination direction angle of first strobe device 35 from first strobe device 35, as a second signal. Thereby, the illumination direction angle of second strobe device 36 is changed to the desired illumination direction angle. Thus, in stroboscopic photography using a plurality of strobe devices, the illumination direction angle of second strobe device 36 can be remotely adjusted in the position of first strobe device 35.

When the photographer changes the illumination direction angle of first strobe device 35 in the master mode, operation start state detector 13 of first strobe device 35 detects an operation start state. At this time, the angle of light-emitting part 10 is changed in response to the change in the illumination direction angle of first strobe device 35. This helps the operation of changing light-emitting part 10 at a desired illumination direction angle. Thus, the photographer does not need to operate light-emitting part 10 of first strobe device 35 against the mechanical reaction force. As a result, the strobe device set to the master mode, such as first strobe device 35, is hardly damaged.

The method for adjusting the illumination direction angle of a strobe device, the strobe device, and an imaging device equipped with the strobe device of the present invention are not limited to the above exemplary embodiment, and can be subjected to various modifications in the scope without departing from the spirit of the present invention.

For instance, in the example described in the above exemplary embodiment, the illumination direction angle of each strobe device 2 is defined by a relative angle of light-emitting part 10 with respect to strobe body 8. However, the present invention is not limited to this example. For instance, as for the illumination direction angle of each strobe device 2, the angle detector may have an azimuth detector capable of detecting an azimuth, such as a global positioning system (GPS) sensor. With this configuration, the illumination direction angle of each strobe device 2 may be defined by absolute values (an azimuth and a tilt with respect to the horizontal or vertical direction) in the optical axis direction (in the direction perpendicular to the illumination face) in the light-emitting part. Further, the illumination direction angle of each strobe device 2 may be defined by a relative angle with respect to the specific direction (e.g. the photographing direction and object direction) of each strobe body 8 or imaging device 1.

In the example described in the above exemplary embodiment, stroboscopic photography is performed using a plurality of strobe devices 2 such that light is radiated directly to an object. However, the present invention is not limited to this configuration. For instance, in a plurality of strobe devices 2, one, a plurality, or all of strobe devices 2 may be used as strobe devices 2 that support bounce stroboscopic photography. Thus, using a plurality of strobe devices can provide illumination more suitable for photography.

In the example described in the above exemplary embodiment, wireless communication is used as the method for communication between the master strobe device in the master mode and the remote strobe device in the remote mode. However, the present invention is not limited to the above configuration. Examples of other wireless communication include infrared communication, and optical communication based on pulse light emission from the light-emitting part. Further, communication can be made by connecting respective strobe devices 2 and transmitting light or electrical signals for communication therebetween.

The above exemplary embodiment may further include a function of remotely identifying strobe device 2 in the remote mode among a plurality of strobe devices 2. For instance, the following configuration may be used. When strobe device 2 in the master mode gives a response-operation command to strobe devices 2 in the remote mode, only strobe devices 2 in the remote mode perform a predetermined operation in the plurality of strobe devices 2. This configuration can change the illumination direction angle of only specific strobe devices 2, and provide illumination more suitable for photography. Examples of the “predetermined operation” include the reciprocating motion of the light-emitting part by a predetermined angle, and light emission (e.g. flashing, lighting, and blinking) of the light-emitting part, backlight-emitting part, infrared-emitting part, or the like. Further, the following configuration may also be used. Each strobe device 2 in the remote mode stores the angle of the light-emitting part thereof. After each strobe device in the remote mode responds to the response-operation command from strobe device 2 in the master mode, each remote strobe device returns to the angle before the response operation. This configuration allows zero return operation after the completion of the photography.

In the example of the above exemplary embodiment, operation part 18 of strobe device 2 is disposed on strobe body 8. However, the present invention is not limited to this configuration. For instance, the operation part may be disposed on the light-emitting part or imaging device 1.

In the example described in the above exemplary embodiment, strobe device 2 is detachably mounted. However, the present invention is not limited to this configuration. Strobe device 2 may be incorporated in imaging device 1. Thus, the present invention is applicable to a strobe device with an automatic bounce function that is incorporated in a digital compact camera, for example. In this case, controller 17 of strobe device 2 is incorporated in imaging device 1 and controls the strobe device by wire or wireless communication.

As described above, the present invention provides a method for adjusting the illumination direction angle of a strobe device or a group of strobe devices in a plurality of strobe devices when an object is photographed using the plurality of strobe devices, each including a strobe body and a light-emitting part. The method includes the following steps of:

transmitting to a specific strobe device in the plurality of strobe devices, a first signal related to a present illumination direction angle of the strobe device being adjusted;

based on the first signal, causing an illumination direction angle of the specific strobe device to correspond to the illumination direction angle of the strobe device being adjusted;

changing the illumination direction angle of the specific strobe device to a state desirable for the strobe device being adjusted;

transmitting to the strobe device being adjusted, a second signal representing an amount of change in the illumination direction angle of the specific strobe device made further from the illumination direction angle changed based on the first signal; and

based on the second signal, changing the illumination direction angle of the strobe device being adjusted.

With this method, first, based on the first signal, the specific strobe device changes the illumination direction angle thereof such that the illumination direction angle corresponds to the present illumination direction angle of the strobe device being adjusted. At this time, the photographer adjusts the illumination direction angle of the specific strobe device to a state desirable for the strobe device being adjusted, by regarding the specific strobe device as the strobe device being adjusted. Then, the second signal is transmitted from the specific strobe device to the strobe device being adjusted, and thereby the illumination direction angle of the strobe device being adjusted is changed to the desired illumination direction angle. As a result, operating the specific, self strobe device can adjust the illumination direction angle of the other strobe device being remotely adjusted.

The present invention provides a strobe device used when an object is photographed, using a plurality of strobe devices including a self strobe device and another strobe device. Each of the strobe devices includes a strobe body, a light-emitting part capable of changing an illumination direction angle thereof, a signal transmitter-receiver, and a controller. The controller of the self strobe device changes an illumination direction angle of the self strobe device, based on a first signal that is related to a present illumination direction angle of the other strobe device and is received by the signal transmitter-receiver of the self strobe device, such that the illumination direction angle thereof corresponds to the illumination direction angle of the other strobe device. When the changed illumination direction angle is further changed to a state desirable for the other strobe device, the controller of the self strobe device controls such that the amount of change from the illumination direction angle changed based on the first signal to the further changed illumination direction angle is transmitted, as a second signal, from the signal transmitter-receiver to the other strobe device. The controller of the other strobe device controls such that the illumination direction angle of the other strobe device is changed based on the second signal.

With this configuration, first, based on the first signal transmitted from the other strobe device, the illumination direction angle of the self strobe device is changed to the present illumination direction angle of the other strobe device. At this time, the photographer changes the illumination direction angle of the self strobe device to a state desirable for the other strobe device. Then, the second signal is transmitted to the other strobe device, and thereby the illumination direction angle of the other strobe device is changed to the desired illumination direction angle. As a result, the illumination direction angle of the other strobe device can be remotely adjusted in the position of the self strobe device.

The present invention provides a strobe device used when an object is photographed, using a plurality of strobe devices including a self strobe device and another strobe device. Each of the strobe devices includes a strobe body, a light-emitting part capable of changing an illumination direction angle thereof, a signal transmitter-receiver, and a controller. The controller of the self strobe device controls such that a first signal related to a present illumination direction angle of the self strobe device is transmitted from the signal transmitter-receiver thereof to the other strobe device. When an illumination direction angle of the other strobe device changed based on the first signal is further changed, the controller of the other strobe device controls such that an amount of the change further made from the illumination direction angle changed based on the first signal is transmitted as a second signal. Further, the controller of the self strobe device controls such that the illumination direction angle of the self strobe device is changed based on the second signal received by the signal transmitter-receiver thereof.

With this configuration, first, the first signal is transmitted to the other strobe device such that the illumination direction angle of the other strobe device corresponds to the illumination direction angle of the self strobe device. At this time, the photographer changes the illumination direction angle of the other strobe device to an illumination direction angle desirable for the self strobe device. Then, the second signal is transmitted from the other strobe device and thereby the illumination direction angle of the self strobe device is changed to the desired illumination direction angle. As a result, the illumination direction angle of the self strobe device can be remotely adjusted in the position of the other strobe device.

The present invention provides a strobe device used when an object is photographed, using a plurality of strobe devices including a self strobe device and another strobe device. Each of the strobe devices includes a strobe body, a light-emitting part capable of changing an illumination direction angle thereof, a signal transmitter-receiver, a controller, and a selector. The selector has a first mode in which an illumination direction angle of the other strobe device is changed, and a second mode in which an illumination direction angle of the self strobe device is changed in response to the other strobe device in the first mode. When the selector of the self strobe device is in the first mode, the following control is performed. The controller of the self strobe device changes the illumination direction angle of the self strobe device, based on a first signal that is related to a present illumination direction angle of the other strobe device and is received by the signal transmitter-receiver of the self strobe device, such that the illumination direction angle of the self strobe device corresponds to the illumination direction angle of the other strobe device. When the changed illumination direction angle is further changed to a state desirable for the other strobe device, the controller of the self strobe device controls such that the amount of change from the illumination direction angle changed based on the first signal to the further changed illumination direction angle is transmitted, as a second signal, from the signal transmitter-receiver to the other strobe device. Further, the controller of the other strobe device controls such that the illumination direction angle of the other strobe device is changed based on the second signal. When the selector of the self strobe device is in the second mode, the following control is performed. The controller of the self strobe device controls such that a first signal related to a present illumination direction angle of the self strobe device is transmitted from the signal transmitter-receiver thereof to the other strobe device. When the illumination direction angle of the other strobe device changed based on the first signal is further changed, the controller of the other strobe device controls such that an amount of change further made from the illumination direction angle changed based on the first signal is transmitted as a second signal. Further, the controller of the self strobe device controls such that the illumination direction angle of the self strobe device is changed based on the second signal received by the signal transmitter-receiver thereof.

With this configuration, when the first mode is selected, the following operation is performed. First, the illumination direction angle of the self strobe device is changed based on the first signal transmitted from the other strobe device such that the illumination direction angle of the self strobe device corresponds to the present illumination direction angle of the other strobe device. At this time, the photographer changes the illumination direction angle of the self strobe device to a state desirable for the other strobe device. Then, the second signal is transmitted to the other strobe device, and thereby the illumination direction angle of the other strobe device is changed to the desired illumination direction angle. As a result, the illumination direction angle of the other strobe device can be remotely adjusted in the position of the self strobe device.

When the second mode is selected, the following operation is performed. First, the first signal is transmitted to the other strobe device such that the illumination direction angle of the other strobe device corresponds to the illumination direction angle of the self strobe device. At this time, the photographer changes the illumination direction angle of the other strobe device to an illumination direction angle desirable for the self strobe device. Then, the second signal is transmitted from the other strobe device, and thereby the illumination direction angle of the self strobe device is changed to the desired illumination direction angle. As a result, the illumination direction angle of the self strobe device can be remotely adjusted in the position of the other strobe device.

The strobe device of the present invention further includes an operation start state detector for detecting an operation start state where the angle of the light-emitting part with respect to the strobe body is changed. The controller controls such that the angle of the light-emitting part is changed in response to the operation start state detected by the operation start state detector.

With this configuration, when the photographer changes the illumination direction angle of the strobe device, the operation start state detector detects the operation start state of the strobe device. Then, the angle of the light-emitting part of the strobe device is changed in response to the change in the illumination direction angle of the strobe device. This can help the operation of changing the light-emitting part to the desired illumination direction angle. As a result, the photographer does not need to forcibly operate the light-emitting part against the mechanical reaction force, and thus the damage, for example, of the strobe device can be suppressed.

An imaging device of the present invention includes the above strobe device. This configuration achieves an imaging device that has high operability or workability and can take a photograph with good timing.

In the imaging device of the present invention, the controller of the strobe device may be incorporated in the imaging device and control the strobe device by communication with the strobe device incorporated in the imaging device. With this configuration, a compact camera including the strobe device, for example, can perform the similar operation.

### INDUSTRIAL APPLICABILITY

The present invention can remotely adjust the illumination direction angles of a plurality of strobe devices, and thus is useful in the technical field of a strobe device and an imaging device for use in stroboscopic photography using a plurality of strobe devices.

### REFERENCE MARKS IN THE DRAWINGS

1 Imaging device
2 Strobe device
3 Imaging function part
4 Arithmetic part
5 Display part
6, 18 Operation part
8 Strobe body
8a Top face
8b Bottom face
8c Front face
8d Rear face
9 Flash discharge tube
10 Light-emitting part
10a One face
11 Variable mechanism
12 Driver
13 Operation start state detector
14 Angle detector
15 Signal transmitter-receiver
16 Selector
17 Controller
19 Opening
20 Vertical-direction variable mechanism
21 Horizontal-direction variable mechanism
22 Vertical-direction driver
23 Horizontal-direction driver
24 Vertical-direction potentiometer
25 Horizontal-direction potentiometer
26 Vertical-direction angle detector
27 Horizontal-direction angle detector
28 Mode selector
29, 30 Channel selector
31 Converter
32 Arithmetic section
33 Control section
34 Storage
35 First strobe device
36 Second strobe device
37 Third strobe device

1. A method for adjusting an illumination direction angle of a strobe device or a group of strobe devices in a plurality of strobe devices when an object is photographed using the plurality of strobe devices, each of the strobe devices including a strobe body and a light-emitting part,
the method comprising the steps of:
transmitting to a specific strobe device in the plurality of strobe devices, a first signal related to a present illumination direction angle of the strobe device being adjusted;
based on the first signal, causing an illumination direction angle of the specific strobe device to correspond to the illumination direction angle of the strobe device being adjusted;
changing the illumination direction angle of the specific strobe device to a state desirable for the strobe device being adjusted;
transmitting, to the strobe device being adjusted, a second signal representing an amount of change in the illumination direction angle of the specific strobe device made further from the illumination direction angle changed based on the first signal; and
based on the second signal, changing the illumination direction angle of the strobe device being adjusted.

2. A strobe device used when an object is photographed, using a plurality of strobe devices including a self strobe device and an other strobe device,
each of the strobe devices comprising:
a strobe body;
a light-emitting part capable of changing an illumination direction angle thereof;
a signal transmitter-receiver; and
a controller,
wherein the controller of the self strobe device changes an illumination direction angle of the self strobe device, based on a first signal that is related to a present illumination direction angle of the other strobe device and is received by the signal transmitter-receiver of the self strobe device, such that the illumination direction angle of the self strobe device corresponds to the illumination direction angle of the other strobe device,
when the changed illumination direction angle is further changed to a state desirable for the other strobe device, the controller of the self strobe device controls such that an amount of change from the illumination direction angle changed based on the first signal to the further changed illumination direction angle is transmitted, as a second signal, from the signal transmitter-receiver of the self strobe device to the other strobe device, and
the controller of the other strobe device controls such that the illumination direction angle of the other strobe device is changed based on the second signal.

3. A strobe device used when an object is photographed, using a plurality of strobe devices including a self strobe device and an other strobe device,
each of the strobe devices comprising:
a strobe body;
a light-emitting part capable of changing an illumination direction angle thereof;
a signal transmitter-receiver; and
a controller,
wherein the controller of the self strobe device controls such that a first signal related to a present illumination direction angle of the self strobe device is transmitted from the signal transmitter-receiver of the self strobe device to the other strobe device,
when an illumination direction angle of the other strobe device changed based on the first signal is further changed, the controller of the other strobe device controls such that an amount of the change further made from the illumination direction angle changed based on the first signal is transmitted as a second signal, and
the controller of the self strobe device controls such that the illumination direction angle of the self strobe device is changed based on the second signal received by the signal transmitter-receiver of the self strobe device.

4. A strobe device used when an object is photographed, using a plurality of strobe devices including a self strobe device and an other strobe device,
each of the strobe devices comprising:
a strobe body;
a light-emitting part capable of changing an illumination direction angle thereof;
a signal transmitter-receiver;
a controller; and
a selector,
wherein the selector has a first mode in which an illumination direction angle of the other strobe device is changed, and a second mode in which an illumination direction angle of the self strobe device is changed in response to the other strobe device in the first mode,
in a case where the selector of the self strobe device is in the first mode,
the controller of the self strobe device changes the illumination direction angle of the self strobe device, based on a first signal that is related to a present illumination direction angle of the other strobe device and is received by the signal transmitter-receiver of the self strobe device, such that the illumination direction angle of the self strobe device corresponds to the illumination direction angle of the other strobe device,
when the changed illumination direction angle is further changed to a state desirable for the other strobe device, the controller of the self strobe device controls such that an amount of change from the illumination direction angle changed based on the first signal to the further changed illumination direction angle is transmitted, as a second signal, from the signal transmitter-receiver of the self strobe device, to the other strobe device, and
the controller of the other strobe device controls such that the illumination direction angle of the other strobe device is changed based on the second signal, and
in another case where the selector of the self strobe device is in the second mode,
the controller of the self strobe device controls such that a first signal related to a present illumination direction angle of the self strobe device is transmitted from the signal transmitter-receiver of the self strobe device to the other strobe device,
when the illumination direction angle of the other strobe device changed based on the first signal is further changed, the controller of the other strobe device controls such that an amount of the change further made from the illumination direction angle changed based on the first signal is transmitted as a second signal, and
the controller of the self strobe device controls such that the illumination direction angle of the self strobe device is changed based on the second signal received by the signal transmitter-receiver of the self strobe device.

5. The strobe device of claim 2, further comprising an operation start state detector for detecting an operation start state where an angle of the light-emitting part with respect to the strobe body is changed, wherein the controller controls such that the angle of the light-emitting part is changed in response to the operation start state detected by the operation start state detector.

6. An imaging device comprising the strobe device of claim 2.

7. The imaging device of claim 6, wherein the controller of the strobe device is incorporated in the imaging device and controls the strobe device by communication with the strobe device incorporated in the imaging device.

8. The strobe device of claim 4, further comprising an operation start state detector for detecting an operation start state where an angle of the light-emitting part with respect to the strobe body is changed, wherein the controller controls such that the angle of the light-emitting part is changed in response to the operation start state detected by the operation start state detector.

9. An imaging device comprising the strobe device of claim 3.

10. An imaging device comprising the strobe device of claim 4.

11. An imaging device comprising the strobe device of claim 5.

12. An imaging device comprising the strobe device of claim 8.

13. The imaging device of claim 9, wherein the controller of the strobe device is incorporated in the imaging device and controls the strobe device by communication with the strobe device incorporated in the imaging device.

14. The imaging device of claim 10, wherein the controller of the strobe device is incorporated in the imaging device and controls the strobe device by communication with the strobe device incorporated in the imaging device.

15. The imaging device of claim 11, wherein the controller of the strobe device is incorporated in the imaging device and controls the strobe device by communication with the strobe device incorporated in the imaging device.

16. The imaging device of claim 12, wherein the controller of the strobe device is incorporated in the imaging device and controls the strobe device by communication with the strobe device incorporated in the imaging device.
